(19) United States
(12) Patent Application Publication
(10) Pub. No.: US 2011/0223576 A1
(43) Pub. Date: Sep. 15, 2011

(54) System for the Administration of a Secure, Online, Proctored Examination

(76) Inventors: David Foster, Phoenix, AZ (US); Russ Bonsall, Phoenix, AZ (US); Jeff Caddell, Phoenix, AZ (US); William Dorman, Phoenix, AZ (US); Laura Perryman, Scottsdale, AZ (US); John Peeke-Vout, Phoenix, AZ (US)

(21) Appl. No.: 12/723,663

(22) Filed: Mar. 14, 2010

(51) Int. Cl. G09B 7/00

(52) U.S. Cl. 434/362

(57) ABSTRACT

A system for secure, web-based, proctored examinations is provided. A web-based platform allows for test delivery beyond a local testing center with the test delivered directly to the test-taker. Computing devices that have been secured for the taking of an examination allow a student or prospective professional to access an examination wherever there is an Internet connection. As a result, students and professionals can take examinations where they live, learn, and work thereby reducing the costs associated with travelling to testing centers and minimizing time away from work. Test-takers, proctors, instructors, administrators, authors, and test developers can all access data and test information anytime and anywhere. Secure examinations can be taken under the purview of a proctor either in person or via the Internet and utilizing any number of testing environment capture devices in conjunction with data forensic technologies.

### CROSS-REFERENCE TO RELATED APPLICATIONS

The present application is related to co-pending U.S. patent application Ser. No. ______ entitled “Secure Online Testing” and U.S. patent application Ser. No. ______ entitled “Online Proctoring,” each filed on Mar. 14, 2010. The disclosure of each of the aforementioned applications is incorporated herein by reference.

### BACKGROUND OF THE INVENTION

1. Field of the Invention

The present invention generally relates to online testing. More specifically, the present invention concerns administering and proctoring of a secure online test.

2. Description of the Related Art

Tests are used to determine the ability of a test taker such as a student or prospective practitioner as it pertains to proficiency in a particular subject or skill set. For example, a student might take a test to determine whether the student possesses requisite knowledge in a particular subject that might be related to receiving a degree or certificate. A prospective practitioner in law or medicine might similarly sit for examination to determine their competence as it pertains practicing in that profession.

Students or prospective practitioners have historically gathered at the designated locale for an examination on a proscribed date and time. Testing materials are then handed out by a testing authority and the test begins. During the allotted test time, the test takers read questions and provide answers on a provided answer sheet or in a ‘blue book.’ Throughout the course of the examination, a teacher or a proctor keeps careful watch over the test takers to ensure that no instances of cheating are taking place. While a single proctor may be able to observe a small group of test takers, such observation becomes more difficult for a larger test taking pool or for a group of test takers utilizing laptop computers or other computing devices.

The increased popularity of distance learning has also complicated proctoring of examinations. The distance learning instructional model delivers education material and information to students who are not physically ‘on site’ at an educational facility. Distance learning provides access to learning opportunities when the source of the information and the student are separated by time or distance if not both. Thousands of distance learners may be involved in a particular distance learning program or course at any given time.

Distance learning is no different than any other educational program in that there is a need to verify the qualifications of students through testing and examination. Because distance learners are not collectively gathered at a physical learning institution such as a university, the distance learning program often requires that the students attend a testing center—which defeats a purpose of distance learning—or administers an examination online. An online examination is difficult to proctor as a user could be taking an examination in one window of a web browser while looking up answers in another window via the Internet. A test taker could also utilize a ‘chat’ or ‘messaging’ application to relay questions to and receive answers from a knowledgeable third-party. The value of online examinations is, therefore, questionable and calls into question the overall value of the corresponding class or degree program.

There is a need in the art for improved proctoring of large scale examinations such that a small number of proctors can properly secure a test taking environment notwithstanding the large number of test takers. There is a similar need for remote proctoring of examinations. Remote proctoring, like on-site massed proctoring, would maintain the integrity of the testing environment by preventing test takers from accessing illicit information to aid in the completion of the examination.

### SUMMARY OF THE CLAIMED INVENTION

A system for administration of a secure, online, proctored examination.

### BRIEF DESCRIPTION OF THE DRAWINGS

FIG. 1 illustrates a test taking environment for online proctored examination.

FIG. 2 illustrates a method for implementing an online proctored examination.

FIG. 3 illustrates a branded interface for establishing a test taker account.

FIG. 4 illustrates an interface for scheduling an online proctored examination.

FIG. 5 illustrates a method related to capturing biometric information utilized in an online proctored examination

FIG. 6 illustrates an interface for capturing biometric information related to keystroke analytics.

FIG. 7 illustrates an interface for capturing biometric information related to visual recognition of a test taker.

FIG. 8 illustrates a first interface utilized in proctoring an online examination.

FIG. 9 illustrates a second interface utilized in proctoring an online examination and that may be launched in response to detecting aberrant behavior observed in the interface of FIG. 8.

### DETAILED DESCRIPTION

Embodiments of the present invention allow for implementing secure, web-based, proctored examinations. A web-based testing platform offers a number of advantages over prior art brick-and-mortar testing centers, which tend to rely upon local server-based testing models. A web-based platform allows for test delivery beyond a local testing center with the test delivered directly to the test-taker.

Unlike a traditional testing center that relies upon a local server, computing devices that have been secured for the taking of an examination allow a student or prospective professional to access an examination wherever there is an Internet connection. As a result, students and professionals can take examinations where they live, learn, and work thereby reducing the costs associated with travelling to testing centers and minimizing time away from work. Test-takers, proctors, instructors, administrators, authors, and test developers can all access data and test information anytime and anywhere. Secure examinations can be taken under the purview of a proctor either in person or via the Internet and utilizing any number of testing environment capture devices in conjunction with data forensic technologies.

Embodiments of the present invention likewise allow for easy, cost-efficient, and nearly instantaneous creation of new examinations or changing of test questions. Such changes previously posed an arduous and costly process in that local servers at any number of testing locations had to be updated one-by-one. Through the use of a web-based testing solution, a test or question as a part of a test may be maintained on a single server thereby allowing test managers to access a single examination via the World Wide Web with test takers seeing changes in real-time at log on.

Test delivery and proctoring may also be adjusted to the specific needs of a particular testing provider (e.g., a university or professional association). Testing may be offered at a secure testing location where test takers can take a Web-based examination monitored by an onsite proctor. Examinations may also be offered to a location such as the offices of the professional association offering the examination. Testing may also take place at a location more intimately associated with the test-taker such as their home or work space at their office. In the latter instance, an online proctor may monitor the examination through a testing environment capture device.

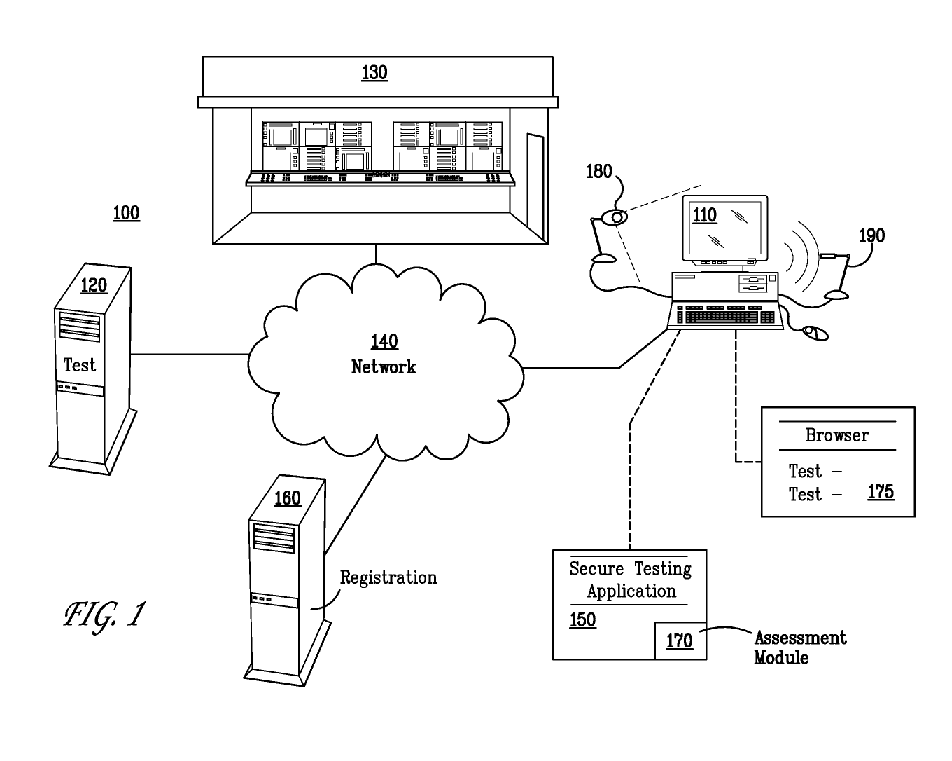

FIG. 1 illustrates a test taking system environment 100. The system 100 of FIG. 1 includes a secure computing device 110 that may be utilized in taking an examination, a testing server 120 for administering a test, a proctoring center 130, and a communications network 140. The communications network 140 allows for the online exchange of testing data by and between the computing device 110 and the testing server 120. The communications network 140 also allows for the observation of testing data and test taker behavior by the proctoring center 130. The computing device 110 of FIG. 1 may be secured for the taking of a test as described in co-pending U.S. patent application Ser. No. 12/571,666 entitled “Maintaining a Secure Computing Device in a Test Taking Device,” the disclosure of which is incorporated herein by reference.

Computing device 110 may be any sort of computing device as is known in the art. Computing device 110 includes memory for storage of data and software applications, a processor for accessing data and executing applications, input and output devices that allow for user interaction with the computing device 110. Computing device 110 further includes components that facilitate communication over communications network 140 such as an RJ-45 connection for use in twisted pair-based 10 baseT networks or a wireless network interface card allowing for connection to a radio-based communication network (e.g., an 802.11 wireless network).

Computing device 110 may be a general purpose computing device such as a desktop or laptop computer. Computing device 110 may be made secure through the implementation of a methodology like that described in U.S. patent application Ser. No. 12/571,666. The general computing device may belong to a particular test taker rather than being a computing device dedicated to test taking and as might otherwise be found in a testing center. Thin client or netbook client devices may be implemented in the context of computing device 110 as might mobile computing devices such as smart phones.

In addition to software applications, the computing device 110 may include any number files or other types of data such as notes, outlines, and test preparation material. Possession of this data—as well as having access to certain applications that themselves allow for access to data (e.g., through a web browser)—during the course of a test or examination would prove highly advantageous to the test taker, but detrimental as to the accuracy or relevance of any resulting test data. Similar issues would exist with respect to a test-center computer that has access to the Internet or that might allow for the introduction of data through a portable storage device.

Testing server 120 is a computing device tasked with the delivery of testing data, including questions, and other related application packages to the computing device 110 by means of communications network 140. Like computing device 110, testing server 120 includes memory, a processor for accessing data and executing applications, and components to facilitate communication over communications network 140 including communications with computing device 110.

Proctoring center 130 is an operations center staffed by one or more persons observing various testing behaviors for one or more testing sites, which may be physically remote from the proctoring center 130. Testing sites can be testing centers dedicated to the offering of tests and examination, traditional classroom settings, as well as personal space such as a home or office workspace. Proctoring center 130 may observe and analyze a variety of different types of information to help ensure the integrity and security of a test and/or testing environment. The observation and analysis of information is described in further detail below with respect to assessment module 170 and camera device 180.

Communication network 140 may be a local, proprietary network (e.g., an intranet) and/or may be a part of a larger wide-area network. The communications network 140 may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. Communications network 140 allows for communication between the various components of test taking system environment 100.

In order to prevent access to files or other types of data such as notes, outlines, and test preparation material during an examination—as well as applications that themselves allow for access to data—it is necessary to secure computing device 110. Computing device 110 may be secured through the download and subsequent installation of secure testing application 150. Secure testing application 150 may be downloaded from testing server 120 or another computing device coupled to communications network 140 such as testing registration server 160. Secure testing application 150 may also be installed from a computer-readable storage device such as a CD-ROM. The testing security application may then be stored in memory at the computing device 110 and executed by a processor to invoke its corresponding functionality.

Secure testing application 150 is a security software application that prevents computing device 110 from accessing certain data or applications that might otherwise be in violation of testing regulations or protocols as identified by testing server 120. Secure testing application 150 causes the computing device 110 to operate in a secure mode by introducing certain changes to the system registry such that only those applications or files deemed necessary or appropriate by the test administrator and as embodied in a corresponding testing protocol may be allocated address space, loaded into memory and ultimately executed by the computing device 110.

For example, a testing protocol for a particular examination may deny access to a web browser, e-mail client, and chat applications such that a test taker may not electronically communicate with other individuals during the examination. This particular protocol may be downloaded to the client computing device 110 from the testing server 120 along with testing data. The secure testing application 150 then operates in accordance with the downloaded testing protocol such that the aforementioned applications are not allowed to be loaded and executed. Because the applications that may be installed on a computing device are all but infinite, the testing protocol may identify those applications that a user is allowed to access rather than those applications to which access is prohibited.

Similar prohibitions or permissions may apply to hardware components of the computing device 110 as well as any number of hardware peripherals that might be introduced to the computing device 110. Examples of such peripherals include a second computer monitor, docking stations, a traditional full-sized keyboard as might be used with a laptop computer. Other peripherals might include thumb drives, ‘time-shift’ recording devices that offer TiVo®-like functionality, as well as any number of other plug-and-play peripherals.

The protocol may also concern hardware at the computing device 110 that involves network connectivity. Network connectivity may be allowed prior to commencing an examination such that certain data may be downloaded. This data may include the actual test (e.g., prompts and questions) or other data concerning a test. Once the certain data is downloaded, however, network connectivity may be deactivated through ‘locking out’ a network card until the test is completed and the network card is ‘released.’ Once the test is complete, the network card may be re-enabled to allow for transmission of data or to allow for the free and general exchange of data rather than a more limited set under the control of the secure testing application 150.

In some instances, network connectivity may be maintained throughout the course of the examination. This may be relevant to a scenario where testing data is maintained at the testing server 120 and only displayed at the computing device 110. In such an instance, the test data itself may never be stored or downloaded at the computing device. It may be necessary to allow certain data to be exchanged over the network connection during the course of the examination. This may include both incoming data (e.g., questions) and outgoing data (e.g., answers).

In those instances where the secure testing application 150 allows access to certain applications on computing device 110, the functionalities of those applications may be limited. For example, a testing protocol may allow for activation of a web browser and network connectivity, but only to a single secure site providing testing data. The protocol may further or alternatively allow for exchanges of only certain types of data or data that has been certified for exchange. Such ‘certifications’ may include the presence of certain headers in the data or the data having been encrypted in a particular fashion. Similarly, the ‘print’ function of a particular application may be disabled. The testing protocol may include instructions on how certain application programming interfaces (APIs) for certain commercially available software applications are to be implemented or disabled by the secure testing application 150. Drivers may be managed in a similar fashion (e.g., a printer driver).

The occurrence of certain milestones or events during a testing event may correspond to the enablement or disabling of hardware, software, or specific application functionality. For example, print functionality may be disabled during an examination to prevent a test taker from printing a copy of the examination and then delivering the copy to a friend so that they may review the questions before they take the examination. That functionality may be enabled, however, to allow the user to keep a copy of their answers sans the questions. The functionality may be re-enabled once a user clicks on a ‘Test Complete’ button or icon that locks in the test taker's answers and prevents them from being further manipulated once certain computing device 110 hardware, software, or functionality has been re-enabled that was otherwise disabled during the examination.

Because APIs vary in each application—and even between versions of the same application—the secure testing application 150 (per the testing protocol) may only allow for the user of certain versions or types of software applications (e.g., only version 3.0.13 of the Firefox web browser). If a user attempts to use a different version or type of application, the secure testing application 150 will prevent execution of that application or specific version thereof. The secure testing application 150 may further inform the user that an upgrade or different type of browser is required. As such, a test taker may be informed of certain system requirements in advance of an examination.

In some instances, the examination may involve a native application 175 in conjunction with or as a part of the secure testing application 150. Native application 175 may encompass an application created by the testing administrator or otherwise developed specifically for administration of online examinations. Native application 175 may offer the general functionality of certain commercially available software applications, but without the functionality that offers possibility for engaging in illicit behavior during an examination. For example, a word processing application offers the ability for a user to produce the text for a document according to instructions. That same application, however, also allows the user the ability to access other notes created using the word processor.

In order to prevent illicit testing behavior, the word processor must allow for the generation of information through the usual input of data, but prohibit access to preexisting data. The word processor must also be prevented from ‘pasting’ data that might have been ‘copied’ from study notes immediately prior to the examination commencing. Notwithstanding, the test taker must still be allowed for a user to ‘cut and paste’ from originally generated answers during the course of the examination.

To implement these specific degrees of control, those specific limitations must first be identified and then conceived as to particular limitations (i.e., what is allowed and what is prohibited). A testing protocol must then be crafted that embodies these permission and prohibitions. To implement the protocol then requires interacting with various APIs, which is dependent upon a user having a particular type of software application and version thereof installed. A natively derived word processing application may simply offer requisite functionality rather than cobble together a series of permitted functions in a commercially available word processing application.

In other instances, a commercial application such as Word for Windows® may be hosted at the testing server 120 or some ancillary server in the testing environment 100 and allow for user access to the same during the examination. By maintaining centralized hosting of a requisite application, users are prohibited from exceeding the permitted use of that same application on their own computer 110. In such an instance, the computing device 110 utilized by the user (as well as that of the testing server 120) may require hardware or software to allow for such multiplexed access and interaction. In some instances, this software may be an integrated part of secure testing application 150. In other instances, however, a user may be required to install this software from a third-party, which may be certified by the entity offering the test or examination.

A natively derived application 175 prepared for use in the testing taking system environment 100 may be provided with respect to a web browser. This native browser may allow access to only those web sites directly related to the test (e.g., providing examination questions) or that provide pre-approved test materials such as manuals, regulations, or rules that might be referenced and cited by an applicant during an ‘open book’ type examination. A native application 175 might also encompass a uniquely generated offering of questions in the context of a multiple choice type examination. Such an application may be akin to a ‘survey’ that a user might otherwise take on any number of websites on the Internet. In such an application, the user is allowed to select a predetermined slate of options and only those options; access to any other applications on the computing device 110 becomes irrelevant and unnecessary.

A native application 175 may also operate in conjunction with a commercial application during testing. For example, a testing protocol may indicate that all chat or electronic-mail applications are to be disabled by the secure testing application 150, but that the test taker may use a commercially available word processing application with limited functionality. The test administrator may wish to offer technical assistance to the test taker during the course of the examination in case some aspect of the test becomes corrupted with respect to the delivery of data. A native application 175 dedicated to instant messaging or ‘chatting’ with an approved technical support agent may be provided for use during the examination.

Secure testing application 150 may include an assessment module 170. The assessment module 170 observes activity on the computing device 110 during administration of an examination. If a user attempts to make changes to the system registry that were implemented by the secure testing application 150, the assessment module 170 may identify and report these attempts to the proctoring center 130. The assessment module 170 may also check an output file for metadata or a keystroke log that might indicate an attempt to switch between accounts if a particular operating system allows for multiple users (each of which would have their own unique system registry) or operating system environments in the case of a computing device 110 operating with the user of a virtual machine. The assessment module 170 may further allow the proctoring center 130 a real-time look into modifications or activity occurring at the computing device 110 including changes at the registry level or activity occurring on-screen.

Secure testing application 150 and assessment module 170 may operate in conjunction with a peripheral device such as camera device 180. Camera device 180, which may be a commercially available web camera or other image acquisition device, generates data of the test taking area and the test taker. If the test taker leaves their seat or another individual enters the testing area during the course of the examination, the camera device 180 will capture this visual information and provide that data to the assessment module 170. The assessment module 170, in turn, delivers the data to the proctoring center 130 for analysis.

The proctoring center 130 analyzes remotely acquired data, which requires a network connection to allow for delivery of that data from the computing device 110 to the proctoring center 130. The testing protocols as delivered by the testing server 120 may instruct the secure testing application 150 to allow the network card to remain enabled, but to limit network connectivity to certain ports. For example, with respect to electronic-mail, an SMTP service operates on port 25 while a POP3 service operates with respect to port 110. The secure testing application 150 would prohibit access to ports 25 and 110, but would allow the use of port 755 with respect to accessing Microsoft Media Services, to the extent those services were used by the proctoring center 130 to observe video of the test taker at the computing device 110. The operability of a universal serial bus (USB) port to provide for connection of the camera device 180 to the assessment module 170 may be required in those instances where a camera device 180 is not embedded in the computing device 110.

The proctoring center 130 may then determine if any visual activity constitutes activity not in accordance with the testing protocol. The proctoring center 130 may then log the information for further assessment by the actual test administrator (e.g., the professor or professional association administering the examination) or make a direct inquiry of the test taker as to the nature of the observed behavior and/or provide a warning as to terminate that behavior. Other external devices may be used to gather environmental data that can be reported to the proctoring center 130 in association with the assessment module 170 such as a microphone or other testing environment capture device 190.

The assessment module 170 may be used in conjunction with the collection of registration information such as a name or testing identification number as well as a password. Other registration information might include biometric information such as a visual image of the user that is compared against a previously stored and known ‘good’ image of the user. A similar comparison may be made with respect to a voice print. Retinal scans and finger prints, subject to the presence of the appropriate peripheral device, may also be used for verifying test taker identity. These peripheral devices may be implemented in the context of a testing environment capture device 190.

A further registration technique may include the user typing in a previously typed in phrase. The nuances of the user having entered the sentence previously and during the actual testing event as they pertain to the natural speed, and pauses, and so forth may be observed and compared. As a result, the likelihood that the test taker is the purported test taker may be determined. All of the aforementioned information may be maintained in storage at a testing registration server 160. The testing registration server 160 may be maintained by the proctoring center 130, in a secure database of information at a site designated by the actual test administrator, or that of a third-party commercial vendor.

The assessment module 170 may also operate in conjunction with a testing protocol to properly execute a testing routine for the given testing event. For example, the testing routine may allow for the user to have access to all questions at any given time such that the user may answer and not answer questions at their leisure and subsequently return to any questions at a later time for further review. The testing routine may alternatively require the user to lock in an answer or set of answers and have the same reported to the testing server 120 prior to receiving a subsequent question.

The routine may alternatively require that a question be locked in, but the actual answers are not delivered to the testing server 120 until conclusion of the examination, a portion of the examination, or as part of a regular batch transmission. Answer delivery may also occur in real-time. As such, the assessment module 170 and the testing server 120 may operate in a binary fashion with certain data being reported to the proctoring center 130 in conjunction with each answer. Other testing routine parameters might include time, number of questions answered, or number of questions answered correctly or incorrectly. Data exchanged between the testing server 120 and the assessment module 170 of the secure testing application 150 may be encrypted.

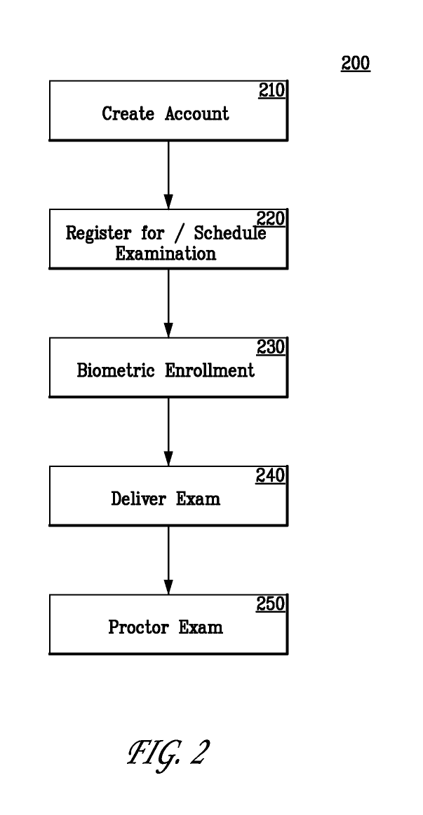

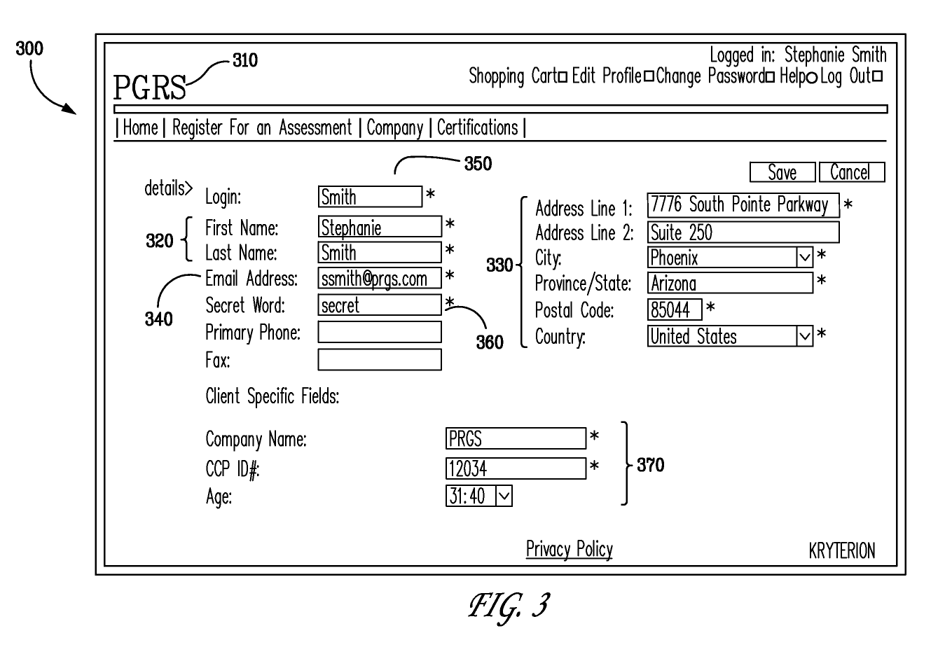

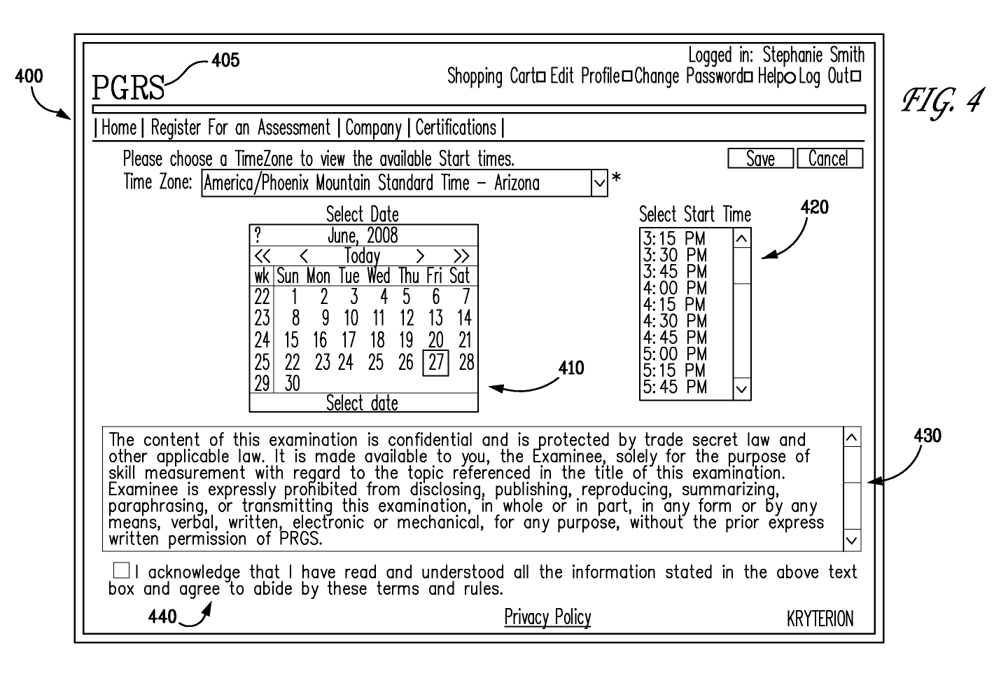

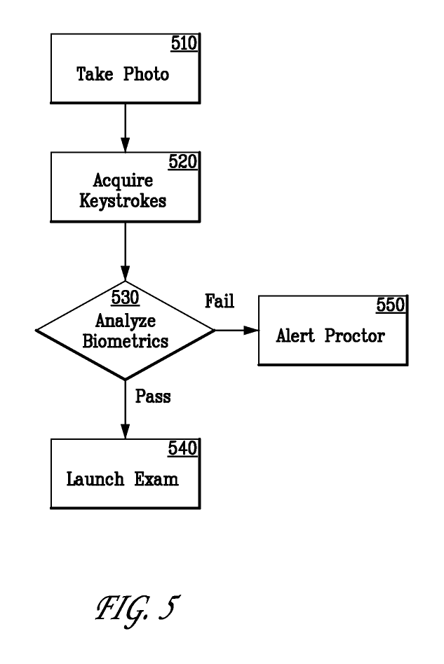

FIG. 2 illustrates a method 200 for implementing an online proctored examination. In step 210, a testing account is created by a test taker. The test taker may utilize an interface like that illustrated in FIG. 3. In step 220, a test taker registers for and/or schedules an examination. The test taker may utilize an interface like that illustrated in FIG. 3 for registration and FIG. 4 for scheduling. In step 230, a test taker engages in biometric enrollment and authentication as is described in greater detail in the context of FIGS. 5, 6, and 7. In step 240 the test is delivered and proctoring commences at step 250.

Proctoring step 250 may take place over the course of the examination and invoke any variety of security technologies and processes may be utilized to deter and detect aberrance during the testing process. By locking down the computing device, the test taker cannot use other applications, keyboard functions such as print or copy, or exit the testing application until allowed by the parameters of a particular examination. If an individual circumvents, attempts to circumvent, or even innocently uses a locked out functionality, that activity is reported to a proctor.

The examination may also be monitored in real-time by a proctoring center 130 utilizing a live video feed of the test taker in real-time. Loss of video or audio feeds may also be reported as may a change in audio or video quality. Historical testing behavior may also be made available as indicia of unusual testing behavior. Real-time data forensic applications may also be implemented that track whether response times are too quick or too slow. Upon identification of such behavior, it may be reported to a proctor.

Other security measures such as one-at-a-time delivery may be implemented to maintain testing security as a part of step 240. Rather than allow a test taker to have access to all testing questions all at once, the questions may be provided as needed to avoid illicit capture or recordation of that information. Delay of delivery or staggered delivery in step 240 may at the least increase the likelihood that such illicit behavior be detected by a proctor thereby increasing the likelihood of illicit activity being detected. Breaks taken by a test-taker may also require re-authentication or permanent lock down and delivery of already provided answers whereby a test taker is not allow to ‘go back’ and revisit or re-answer those questions. The test taker may be reminded as to the finality of any responses prior to taking a break.

FIG. 3 illustrates a branded interface 300 for establishing a test taker account. The interface 300 may be designed for a particular assessment entity such as a university or professional association and reflect a brand (310) of the same. The interface 300 may be particular to a specific class or examination or a series of classes or examinations. Through the interface 300 illustrated in FIG. 3, a test taker provides contact information such as a name (320), address (330), and e-mail address (340) in addition to a login name (350) and password or secret word (360), which may randomly be generated by the assessment entity as assigned to the user. Other information fields that are specific to or required by the test taking entity (370) may be provided. Information provided by the user may be maintained at registration server 160 as described in FIG. 1. An entity offering the assessment services may determine how much information is needed to complete the registration process.

FIG. 4 illustrates an interface 400 for scheduling an online proctored examination. Interface 400 may share similar branding (405) as the registration interface 300 of FIG. 3 where a test taker provided name, address, and other registration information. The scheduling interface 400 of FIG. 4 may be launched following completion of registration activity via interface 300 in FIG. 3 or following a secure login process by providing a user name and password if the test taker has previously registered with the assessment service.

The scheduling interface 400 of FIG. 4 provides a calendar 410 that may identify dates that the examination is provided or to allow the user to select a date of their choice for on-demand testing. The scheduling interface 400 of FIG. 4 also provides a start time menu 420 that may identify available starts times or to allow a user to provide a time of their choice for starting on-demand testing. A disclaimer window 430 may also be provided to communicate any specific information related to the examination including restrictions on use, eligibility, and disclosure. An acknowledgment box 440 may also be provided to allow for a user to acknowledge that they have reviewed (or been offered the opportunity to review) any disclaimer information provided in window 430.

FIG. 5 illustrates a method 500 related to capturing biometric information utilized in an online proctored examination. Based on the specific requirements of each test, a test taker is prompted to capture or allow for the capture of biometric enrollment information. When the test is delivered, a biometric authentication process validates the identity of the test taker and authenticates data authorizing the examination to commence.

In step 510, a biometric enrollment photo of the test taker is taken. This photograph is taken when the test taker initially enrolls in the Web-based testing solution. This picture will later be used in comparison to a photograph of a taker of an actual examination. The photo may be taken using image capture device 180 as illustrated in FIG. 1 or during, for example, registration for a first day of classes at a university.

In step 520, a biometric enrollment keystroke analysis is undertaken. The keystroke analysis creates a biometric profile based on the typing patterns of a test taker. During a later authentication operation, a fraud detection component of the analytics software identifies typing patterns that do not match the biometric enrollment profile. A proctor is then alerted so that appropriate action may be taken.

In step 530, a biometric authentication process takes place. The authentication process of step 530 may compare the previously acquired photograph from step 510 with a current photograph of the test taker and/or compare biometric information related to typing patterns with the previously input typing sample from step 520.

In step 540, if the biometric information from both the photograph and keystroke analysis is within an acceptable range of acceptability, then the examination is launched. If the photograph of the test taker fails to correspond, to that of the test taker at enrollment and/or the typing analytics software identifies an anomaly, then the test is suspended at step 550 and the proper entities are altered with respect to addressing the anomalies. Alternatively, the examination may be allowed to proceed, but under a flag of caution requiring further analysis during grading.

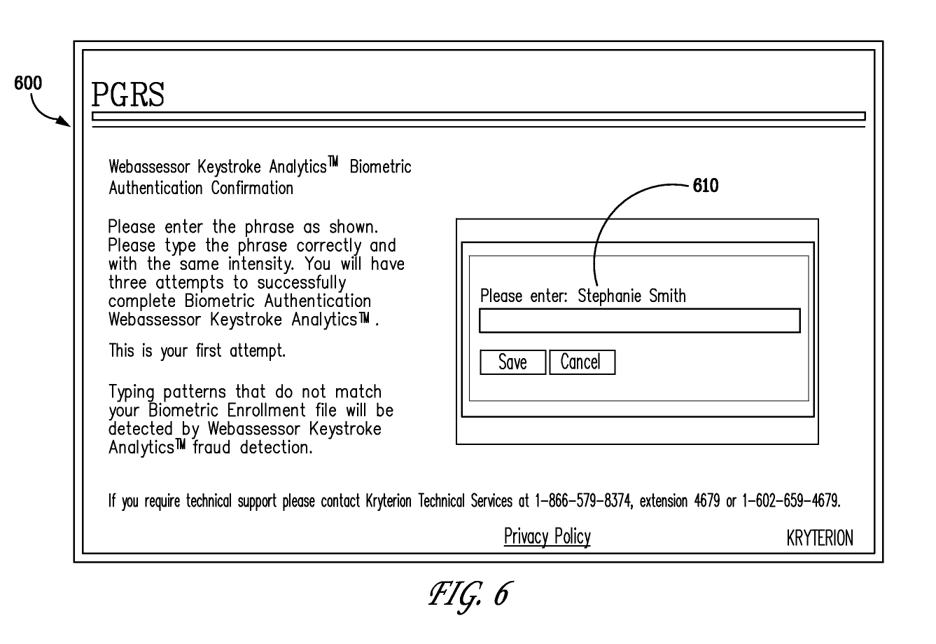

FIG. 6 illustrates an interface 600 for capturing biometric information related to keystroke analytics. The interface 600 of FIG. 6 displays a phrase 610 to be typed by the test taker. Typing patterns of particular series of letters, numerals, and phrases are similar to fingerprints or other biometric information in that they are unique to a particular person. For example, a first test taker will exhibit specific nuances related to the entry of that series of letters, numerals, and phrases versus those of a second test taker. These nuances may include the speed at which the series of letters, numbers, and phrases are entered; pauses between certain letters, numbers, and phrases, and if a keyboard offers pressure sensitive detection, the intensity with which the user enters that information (e.g., how hard the test taker types).

A test taker may be asked to provide a typing sample during a registration activity, which may occur upon initial registration with the assessment provider. Upon the actual taking of the examination (or immediately beforehand) the test taker may be asked to enter the aforementioned phase 610 to verify that the same person is entering the phrase and that the test taker is who they purport to be. The initial sampling may involve a series of random phrases that may be selected at random or that may be analyzed to identify specific typing patterns and then used to generate and analyze a subsequently entered phrase. A test taker may be allowed a finite number of opportunities to enter the phrase prior to a proctor being alerted. This information may be maintained at a registration server 160 or some other computing device tasked with maintaining this information.

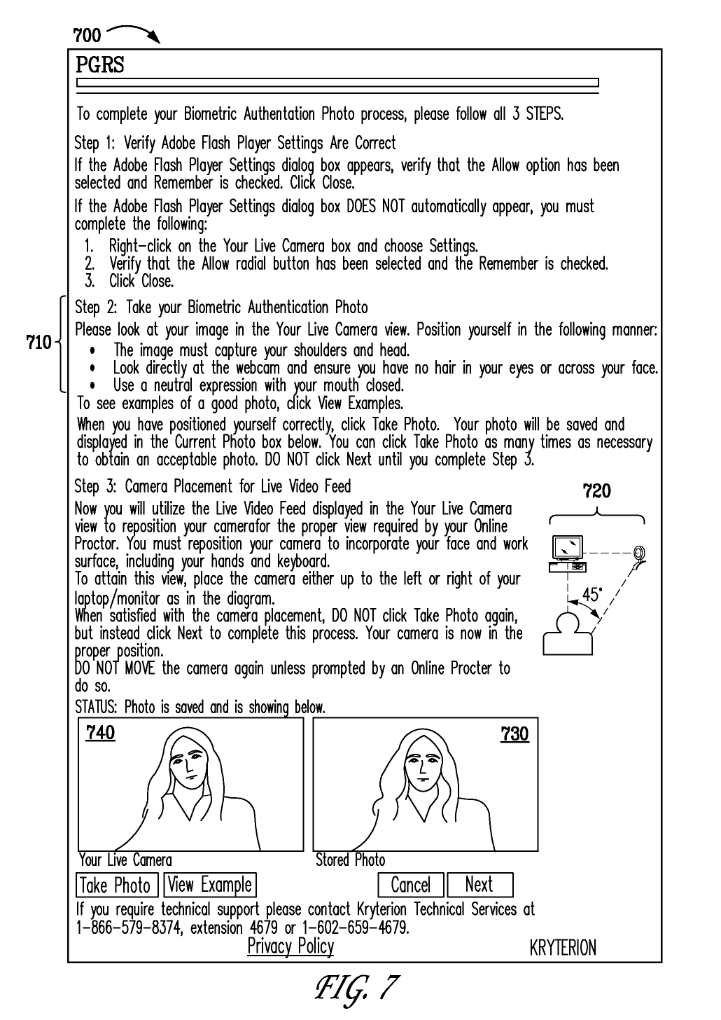

FIG. 7 illustrates an interface 700 for capturing biometric information related to visual recognition of a test taker. Interface 700 provides a test taker with instructions concerning positioning a camera to take a photograph of a user (710). This process may be undertaken at the registration phase and then before the taking of the examination.

Photographs and typing samples may be examined during the course of the examination. For example, a pop-up window may requests intermittent verifications of typing samples and visual identity. The video may also be analyzed in real-time and seamlessly without the involvement of the test taker. The actual entry of test answers may be analyzed for the purpose of ensuring keystroke analytics. FIG. 7 also illustrates instructions concerning placement of an image capture device 180 with respect to a live video feed (720).

The previously stored photograph (730), as discussed in the context of FIG. 5, may then compared to the real-time photograph (740) to ensure that the test taker is who they purported to be. The photograph may be examined by an actual human being at a proctoring center 130 or through the user of facial recognition software that analyzes particular points on the face and body of the test taker to ensure an acceptable degree of commonality that ensures the identity of the test taker. If the registration photograph and the real-time photograph are not consistent, a proctor may be alerted to take further action and to delay administration of the examination as discussed with respect to FIG. 5 at steps 530 and 550.

Other means of ensuring identity or security of a testing locale may be used, including voice sampling and ‘listening in’ to ensure that no third-parties are speaking to the test taker. Comparison of voice samples may occur in a fashion similar to that of comparison of photographs. Further, a voice sample of the test taker may be compared against any other voices detected during the examination process whereby a voice that does not correspond to the test taker triggers proctor intervention.

Other means of verifying the identify of a user might be invoked including the use of a fingerprint or other biometric information through a detection device coupled to the testing device and which may be more common at a dedicated testing center. Providing random information such as a student ID, a driver's license ID, or swiping a credit card or other identification card through a coupled scanning device could also be used.

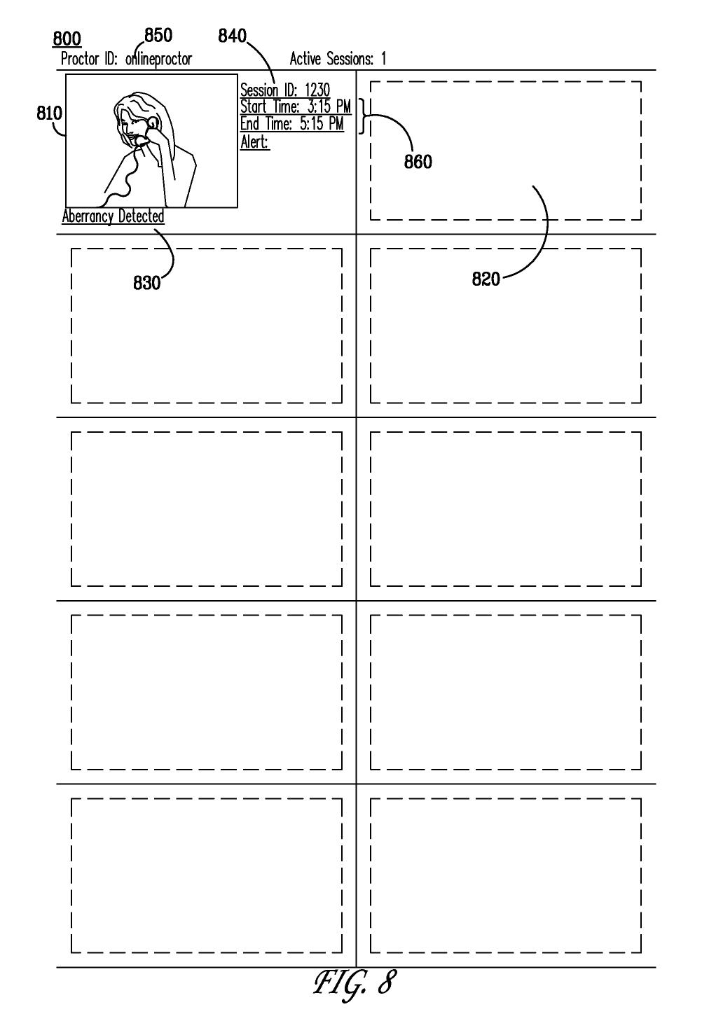

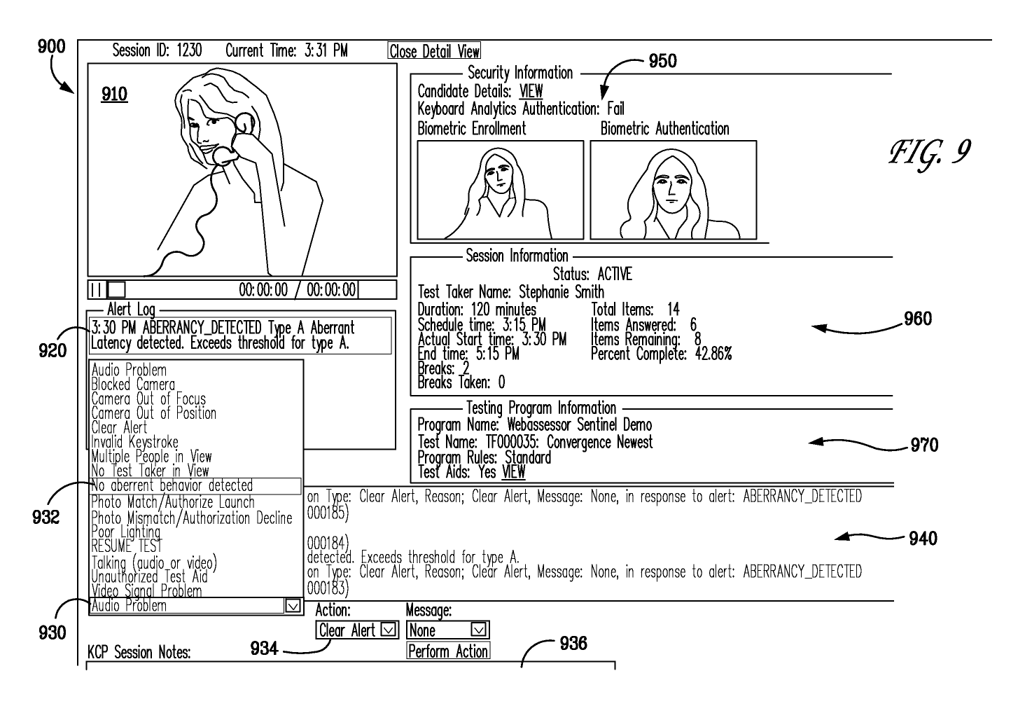

FIG. 8 illustrates a first interface 800 utilized in proctoring an online examination and as might be observed at a proctoring center 130. Interface 800 may allow for simultaneous observation of a number of sessions. As shown in FIG. 8, a single active session 810 is being observed from a total of twelve available sessions (820). As illustrated in FIG. 8A, the session being monitored (810) exhibits aberrant behavior as reflected by alert 830. Aberrant behavior may be automatically detected, which leads to subsequent proctor intervention or in direct response to proctor observation. FIG. 8 also illustrates a session ID 840, which is unique to the test taker; a proctor identification 850, which identifies a proctor responsible for observing the testing session; as well as a start and end time (860) for the testing session. All of this information may be utilized in generating assessment data or logs following completion of the examination. In some instances, aberrant behavior may result in the session automatically being ‘exploded’ into larger view (like in FIG. 9) in case the proctor is responsible for monitoring a large number of students.

Upon the exhibition of aberrant behavior as reflected by alert 830 in FIG. 8, the specific session may be singled out for further investigation through the interface 900 of FIG. 9. FIG. 9 illustrates a second interface 900 utilized in proctoring an online examination and that may be launched in response to detecting aberrant behavior observed in the interface of FIG. 8. The interface 900 of FIG. 9 (like that interface 800 of FIG. 8) illustrates real-time video 910 of the test taker. Recording of the video may take place upon detection of aberrant behavior for the purpose of validating or providing requisite evidence related to addressing disciplinary activity following an affirmative determination that a test taker violated a test taking protocol. In some instances the aberrant behavior may simply be that the testing environment needs to be modified in order to ensure proper proctoring, which could include raising the light level or decreasing background noise (e.g., closing a window). A proctor may provide this information to a test taker.

The interface 900 of FIG. 9 also illustrates a current alert log 920 that identifies the specific aberrant behavior that lead to the automated alert 830 in the interface 800 of FIG. 8. The proctor may log the outcome of their determination related to the aberrant behavior in response log 930. Response log 930 allows a proctor to identify the particular behavior that was at issue (e.g., an audio problem or multiple people being present) (932) and the results of monitoring the aberrant behavior (934), which could include clearing the alert as a false alert, terminating the examination, or inconclusive and allowing the test to continue. A proctor may also launch an on-demand verification of audio, visual, or keystroke analytics. Notes related to the incident may also be maintained in notes section 936 to further detail the specific incident. In some instances, the proctor may launch a live chat session with the test taker while maintaining real-time observation.

The interface 900 may also maintain additional information such as a historical alert log 940 that maintains a running list of all aberrant behavior for the test taker in question as well as security information 950, session information 960, and testing program information 970. Security information 950 may display specific information about a test taker, including biometric information such as a photograph. Session information 960 may display information such as the name of the test taker, the number of testing items answered, the number of breaks taken, and so forth as illustrated in FIG. 9. Information concerning specific protocols related to the examination may be identified in testing program information window 970.

Logging of aberrant behavior may be tied to audio and video feeds of testing behavior. In such instances, a proctor may simply log the unusual behavior but leave it to the test assessment authority as to the ultimate disciplinary behavior. Providing audio and video context tied to the alert may be useful in this regard.

Through utilization of the presently described Web-based testing and proctoring methodologies, a test taker can view and print formatted results of completed tests and examinations. Test takers may also register for tests and examinations from a personalized home page. Self-service registration and scheduling of proctored and un-proctored assessments simplifies the administration component of testing and examination. A catalog of available assessments may also be provided and updated in real-time. Similar benefits_may be offered with respect to retaking examinations, ensuring eligibility for examinations, and providing information regarding the availability or eligibility of certain examinations. Test takers may be allowed to register only for those examinations made available or for which they are eligible.

The presently described Web-based testing and proctoring methodologies may be used by test taking management to create new test taker accounts and edit existing accounts. Account data may be entered manually or imported by a support team. Managing test taker account information may include modifying demographic information, changing account passwords, sending system-wide electronic mail messages, or changing a secret word, ‘reminder,’ or ‘hint.’ Administrators may also capture custom demographic information for test taker reporting, managing assessment registration eligibility, or prerequisite criteria.

Testing administrators may have immediate access to test scoring and results following completion of an examination utilizing the presently described Web-based testing and proctoring methodologies. Test administrators may also manually score assessments that include short-answer or essay questions. Test administrators may also manually score assessments that they have set fort manual review before providing a score to a test taker. A manual scoring function allows for the inclusion of essay questions on testing and examination. Final scores may be held until the completion of a testing window.

Testing data may be organized and stored in libraries or item banks. Items banks can be broken into multiple levels of item folders. To simplify management of items and item banks, an embodiment of the presently described Web-based testing and proctoring methodology utilizes a flexible structure allowing for an administrator to copy and move items, item folders, and item banks within an item bank structure. Administrators may apply security to item banks, which may particularly relevant in a multi-author environment. Security may be applied to item writer roles and include controls for restricting viewing, altering folder structure, and setting permissions for other users.

The presently described Web-based testing and proctoring solution may utilize any number of items, including multiple-choice, multiple-select, matching, true/false, yes/no, short answer/essay, fill in the blank, and single selection. An HTML editor allows for an easy-to-use interface for creating and editing testing items and may include features such as spell-check, text formatting, images and video, tables, and lists to create robust and engaging assessment offerings. Such offerings may be previewed such prior to provisioning such that their appearance to a test taker may be confirmed prior to the actual examination. Psychometric properties may be used to track expiration date, difficulty, and references for various testing items.

The work flow of any testing item may be tracked in implementations of the presently described Web-based testing and proctoring solution. A state may be assigned to each test item corresponding to a current state such as written, edited, technically reviewed, psychometrically reviewed, completed, rejected, and retired. Along with workflow history, a change history may be tracked in order to store and present all changes corresponding to any particular testing item. An interface may present a history of what was changed, when, and to what to simplify tracking.

Test form management may also be enjoyed in embodiments of the presently described testing and proctoring solution. A test form manager interface may allow a user to add items from any item bank to create a particular assessment. When adding items to a test form, the administrator may add an entire item bank, an item folder or multiple folders, specific items within an item bank or specific items within an item folder. Scoring is equally customizable and allows for assignment of an overall score, a topic score, or simple feedback. Overall scores and pass/fail rates may be derived and displayed. An administrator may also allow for generation of feedback by a test taker or as part of a post-mortem of the assessment. Rules for assessment registration and eligibility may likewise be set by the administrator.

Reporting may be customized to allow a testing administrator to run a report that requires specific information needed for a specific program. For example, test/question metrics may be generated that provide a summary of an average score by test; a summary of an average score by topic; results by question; a summary of test by status (e.g., upcoming, in-progress, complete); number of days since registration; and number of days since a test has been in-progress. Program activity may also be tracked to provide information related to tests taken by date (e.g., summary by month, current calendar year, number of tests passed or failed, and number of un-scored tests); number of tests take accounts created (e.g., by region or date); number of tests purchased (e.g., by dates, region, ID, payment method, test) or scheduled; as well as testing results for a region or by date. Test center metrics and activity for particular administration accounts may also be tracked in addition to information related to revenue, dates of test sales, and payment methods.

Computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise

1. (canceled)

2. A system for administration of a secure, proctored examination via a network, the system comprising:
a testing server coupled to the network, the testing server providing testing data for the examination;
a registration server coupled to the network, the registration server receiving authentication data to authenticate a test taker of the examination;
a computing device coupled to the network, the computing device:
providing the authentication data to the registration server so that the registration server may verify a user of the computing device as the test taker,
receiving the testing data to execute a testing routine for the examination,
and
executing a secure testing application that implements security limitations for the computing device during the testing routine and provides observation data concerning the testing routine to a proctoring center; and
a proctoring center that receives the observation data over the network in order to monitor the testing routine executed by the computing device.

3. The system of claim 2, wherein the computing device includes a testing environment capture device that generates environmental observation data of an environment surrounding the computing device during the testing routine, and the secure testing application provides the environmental observation data to the proctoring center during the testing routine.

4. The system of claim 3, wherein the testing environment capture device includes a microphone that generates audio data corresponding to the environment surrounding the computing device.

5. The system of claim 3, wherein the testing environment capture device includes a camera device that generates visual data corresponding to the environment surrounding the computing device.

6. The system of claim 2, wherein the authentication data and the observation data include biometric information of the user, the biometric information captured by a detection device coupled to the computing device.

7. The system of claim 6, wherein the biometric information includes a voice sample of the user captured by a microphone coupled to the computing device.

8. The system of claim 6, wherein the biometric information includes user input to the computing device, the user input corresponding to a typed phrase.

9. The system of claim 2, wherein the proctoring center analyzes the observation data to detect aberrant behavior of the user during the testing routine.

10. The system of claim 2, wherein the testing data includes questions for the examination, and the observation data includes answers to the questions.

11. The system of claim 2, wherein the testing data includes a testing protocol that indicates the security limitations to be implemented by the secure testing application during the testing routine.

12. The system of claim 2, wherein the proctoring center is physically remote from the computing device.

13. The system of claim 2, wherein the security limitations implemented by the secure testing application include prohibiting execution of an application on the computing device.

14. The system of claim 2, wherein the security limitations implemented by the secure testing application include prohibiting access to certain data stored in memory of the computing device.
